(19) United States
(12) Patent Application Publication
(10) Pub. No.: US 2024/0047114 A1
(43) Pub. Date: Feb. 8, 2024

(54) ELECTROMAGNET

(71) Applicant: SVM Schultz Verwaltungs-GmbH & Co. KG, Memmingen (DE)

(72) Inventor: Johann Weiß, Wangen (DE)

(21) Appl. No.: 18/330,612

(22) Filed: Jun. 7, 2023

(30) Foreign Application Priority Data
Jun. 7, 2022 (DE) 102022114324.4

(51) Int. Cl. H01F 7/16; H01F 7/121; H01F 7/129

(52) U.S. Cl. CPC H01F 7/1607; H01F 7/121; H01F 7/129

(57) ABSTRACT

An electromagnet which is penetrated by a longitudinal axis includes: an armature space and an armature which is arranged longitudinally movably in the armature space, the armature having a penetration opening, and the armature supporting at least one closure element which is mounted movably in the penetration opening, the closure element being configured to open or to close the nozzle, the closure element comprising a guiding element, which guides the closure element in the penetration opening, and a sealing element which is supported by the guiding element, wherein the sealing element is held in a non-positive and/or positively locking or floating manner on the guiding element.

### CROSS-REFERENCE TO RELATED APPLICATIONS

This application claims priority to German Patent Application No. 102022114324.4, filed on Jun. 7, 2022, which is incorporated by reference in its entirety.

### FIELD OF THE DISCLOSURE

The invention relates to an electromagnet.

### BACKGROUND

EP 2256389 B1 discloses an electromagnet comprising an armature space and an armature which is arranged longitudinally movably in the armature space. The armature has a penetration opening, and supports a closure element which is mounted movably in the penetration opening. The closure element is configured to open or to close a nozzle. The closure element comprises a guiding element which guides the closure element in the penetration opening, and a sealing element which is supported by the guiding element. The sealing element is connected to the guiding element in an integrally joined manner by way of adhesive bonding, vulcanizing or else welding.

Fastening of this type of the sealing element can in some circumstances, however, be expensive and complicated to produce and assemble. Adhesive bonding, for example, leads to at least one further method step in the assembly on account of the necessary adhesive application. Vulcanizing, for example, leads to high production costs, since the guiding element has to also be inserted into a mould cavity by hand or in an automated manner. Welding is also an energy-intensive fastening method.

In view of global efforts towards resource saving and energy efficiency, it is an object to provide an electromagnet which, firstly, still permits rapid switching times and switching frequencies, and secondly can be produced and assembled less expensively and in a more energy-efficient manner with retention of high seal quality.

### SUMMARY

Disclosed is an electromagnet which is penetrated by a longitudinal axis, comprising: an armature space and an armature which is arranged longitudinally movably in the armature space, the armature having a penetration opening, and the armature supporting at least one closure element which is mounted movably in the penetration opening, the closure element being configured to open or to close a nozzle, the closure element comprising a guiding element, which guides the closure element in the penetration opening, and a sealing element which is supported by the guiding element, the sealing element being held in a non-positive and/or positively locking or floating manner on the guiding element.

An expensive and/or energy-intensive integrally joined fastening which has been used up to now is dispensed with by incorporating the disclosed sealing element. The sealing element is finally held by way of the non-positive and/or positively locking connection, or is finally held or mounted in a floating manner. It has been shown surprisingly that fastenings of this type do not have a negative influence on the seal qualities of the sealing element, but at the same time costs and energy during production and assembly can be saved. The non-positive connection can be realised, for example, by a transition or press fit, the positively locking connection can be realised, for example, by a latching connection (latching geometries running in the longitudinal direction and/or circumferential direction), and the floating holding can be implemented, for example, by a clearance fit.

In particular, the at least one sealing element is held without an integrally joined connection on the guiding element, for which reason complicated vulcanizing can be dispensed with. Dispensing with this additionally avoids that the guiding element has to be inserted into a cavity of a vulcanization mould and, moreover, does not have to be coated for this purpose, for example by adhesion promoter. Adhesion problems are also avoided as a result.

The disclosed electromagnet provides advantages not only during production and assembly, but also during the service life of the electromagnet. Sealing elements of an electromagnet are unavoidably subjected to swelling over their service life on account of a media flow in the armature space and temperature influences. The swelling leads to the sealing element widening spatially. Sealing elements which are held in an integrally joined manner can widen merely in the longitudinal direction, and are additionally fixed in a stationary manner on account of the integrally joined connection, which has a considerable disadvantage on the initially set armature stroke, however, since the swelling and the widening lead to changed spacings. Sealing elements up to now therefore necessarily increase in length over time. Since the electromagnet dispenses with an integrally joined connection of this type, there is the possibility that the sealing element can widen independently of the element, on which it is held, during swelling. The sealing element may possibly likewise widen due to swelling, but can change its relative position with respect to the guiding element during the service life, since it is mounted in a non-positive and/or positively locking or floating manner, and is not fixed spatially by an integrally joined connection which prevents a relative movement of this type. As a result, initially set armature strokes can be ensured reliably and constantly over the service life of the electromagnet, and a durably high sealing quality can be achieved. By way of the constant stroke, a constant throughflow is realised, in particular, in addition to the sealing quality. In aspects, the swelling behaviour therefore does not affect the armature length.

During the assembly of the electromagnet, the at least one sealing element can be pushed into the guiding element, which is possible by way of a simple hand movement or a simple automation process. The sealing element is then held there either by a non-positive and/or positively locking connection or in a floating manner; floating mounting is to be understood to mean play or a clearance fit.

The sealing element is a separate component, in particular with regard to the corresponding guiding element. This makes a separate and independent production of the two components from one another possible, which results in greater design flexibilities and a larger selection of materials, in particular as a result of dispensing with a vulcanisation.

The at least one nozzle can configure a sealing seat and/or can be included by the electromagnet, or else can be part of a component which is not part of the electromagnet. The at least one sealing element is at any rate configured to selectively open or close a corresponding nozzle. A plurality of sealing elements and a plurality of nozzles are conceivable, it also being possible for the nozzles to be included by the electromagnet and to be part of a component which is not part of the electromagnet.

In the case of the electromagnet, the armature space can be filled with medium or can be capable of being filled with medium. The electromagnet can comprise a coil winding, through which electric current can flow, in order to generate a magnetic field in such a way that this magnetic field acts on the armature and moves the armature in the armature space in the longitudinal direction (along the central longitudinal axis).

The armature has the penetration opening which can be filled with medium or can be capable of being filled with medium. The arrangement is selected on the electromagnet in such a way that the penetration opening penetrates the armature, preferably in the longitudinal direction, as a result of which it is possible that the medium flows in a first end-side opening region into the penetration opening, flows through the penetration opening, and leaves the armature again in a second end-side opening region. The armature can therefore be an armature, through the interior of which flow can pass. The armature can configure an inner circumferential-side supporting flange, against which the closure element can bear or can be preloaded.

The armature can bear with its armature shell surface against an armature space inner surface which delimits the armature space. This armature space inner surface can be formed by a pole tube, and is often adapted to the cross section of the armature in terms of its cross section in a prismatic or cylindrical manner and for optimum guidance. In the case of the electromagnet, it is possible that the armature shell surface is closed, that is to say as identical a contact and guidance as possible of the armature on the armature space inner surface is possible. In this way, the bearing surfaces which also act at the same time as guiding surfaces are loaded uniformly, which results in an increase in the service life of the armature and/or correspondingly equipped electromagnet.

The armature supports at least one closure element, and the closure element can selectively open or close a nozzle. A configuration of this type results in a highly compact arrangement of the electromagnet, since the valve function is integrated into the electromagnet itself. Here, the orifice region of a connector line of any desired design can be called a nozzle; depending on the application of the electromagnet (for example, 3/2-way valves or other embodiments), a working connector, a pressure connector and/or a venting connector are understood to be connector lines, for example, the nozzle characteristically arising in the region, in which the cross section through the medium which is to flow tapers or widens.

The at least one closure element is arranged in the penetration opening, preferably in the end region of the penetration opening. The embodiment of the closure element firstly, but also of the armature secondly, can be selected here in such a way that the closure element can interact tightly and reliably with the nozzle edge of the nozzle in the closed position. This can be achieved by way of corresponding overhangs or else steps or shoulders on the closure element firstly and the armature secondly.

The arrangement of the closure element in the penetration opening can be selected in such a way that, in the closed position, the closure element impedes the throughflow of the medium in the penetration opening only insubstantially or to a small extent, if at all. This can be achieved by way of corresponding configuration of the closure element, for example with the arrangement of corresponding flow regions on the closure element.

The electromagnet can be a constituent part of a solenoid valve. A solenoid valve is a valve which is actuated by an electromagnet. Embodiments for controlling hydraulic or pneumatic applications are known here. The armature space, in which the armature of the electromagnet is situated and moves, is characteristically filled or can be filled by a medium, preferably the medium to be controlled. This can typically be a gas, air (compressed air) or else a fluid, as are used in hydraulic applications, for example.

In accordance with one conceivable refinement of the electromagnet, a cross-sectional area, through which flow can pass, of the armature can be greater than a cross-sectional area, through which flow can pass, of one nozzle or the two nozzles. The cross-sectional area, through which flow can pass, can be flowed through by the medium. It is advantageously conceivable that the cross-sectional area, through which flow can pass and which is defined by the flow regions on the closure element and/or between adjacent guiding ribs, of the armature can be greater than the cross-sectional area, through which flow can pass, of one nozzle or the two nozzles. As a result, the volumetric flow through the armature is advantageously not impeded.

In accordance with one conceivable refinement of the electromagnet, a closure element can be arranged in each case at the two axial ends of the penetration opening. The configuration of the closure element or the armature or the penetration opening is also selected here in such a way that the inflow and outflow of the medium from the armature space into the penetration opening and back is not impeded. For example, flow regions on the closure element are conceivable here, and/or an external diameter of the sealing element which is smaller than an internal diameter of the penetration opening, at least in the region of the sealing element. Here, the arrangement of the closure elements in the penetration opening is realised in such a way that reliable closure of the nozzle is ensured by way of the sealing element of the closure element.

In accordance with one conceivable refinement of the electromagnet, the penetration opening can penetrate the armature in the longitudinal direction, preferably completely. In the case of the complete penetration, opening regions are configured at both ends of the armature. In the case of the switching movement of the electromagnet, a magnetic field is generated on account of the electric current in the coil winding, which magnetic field acts on the magnetizable armature and moves the latter. The arrangement of the penetration opening is then preferably parallel to the movement direction of the armature, and the arrangement counteracts the movement of the armature with an even smaller resistance. An arrangement of the penetration opening in the longitudinal direction of the armature also brings about, furthermore, a throughflow optimization, however, since the flow direction of the medium in the armature space is as rectilinear and direct as possible, which leads to a reduction in flow deflections which otherwise produce additional resistance during the movement of the armature on account of the turbulent flow which results in some circumstances.

The armature shell surface of the armature can be a closed armature shell surface, for example a cylindrical armature shell surface. An armature shell surface of this type also leads to a comparatively simple armature configuration, since no grooves, etc. are provided in the shell surface. The closed armature shell surface leads to loading which is as homogeneous as possible of the armature shell surface, since the armature is guided in the armature space via this armature shell surface and, as a result, a corresponding service life increase can be achieved.

In accordance with one refinement of the electromagnet, a supporting spring for the at least one closure element can be provided in the penetration opening, it being possible for at least the one sealing element to be supported via the supporting spring. For reasons of part reduction and construction simplification, merely a single supporting spring can also be arranged in the penetration opening. In order to ensure that the at least one closure element is arranged in a desired position at or in the penetration opening, in particular in the corresponding end region of the penetration opening, a supporting spring can be arranged in the penetration opening.

The configuration and also dimensioning of the supporting spring, preferably as a helical spring, also ensure that the at least one sealing element can press with a sufficient force on the corresponding nozzle (closed position) and thus fulfils the closure function durably and reliably. For this purpose, the corresponding sealing element can be supported directly via the supporting spring, or the supporting spring can bear directly against the corresponding sealing element and preload the latter. Therefore, the supporting spring preferably does not act directly on the guiding element. The guiding element therefore does not have to have any supporting geometries for the supporting spring which might even stand in the way of an insertion of the sealing element during assembly; simple assembly of the sealing element is achieved. Up to now, supporting springs of this type have occasionally not been supported directly on the sealing element, but rather on the element which supports the sealing element. Since, however, the force flow between the supporting spring and the sealing element has up to now had to pass the integrally joined connection which is used, this connection has additionally been loaded continuously. It has therefore had to be of corresponding configuration. The disclosed electromagnet solves this problem in a simple way.

Within the context of the integrally joined connection-free arrangement of the sealing element, the supporting spring additionally serves to further avoid swelling-induced leaks. A possible length change of the sealing element which can be due to swelling can be compensated for by the supporting spring. As a result, initially set armature strokes can also be ensured reliably over the service life of the electromagnet and a permanently high sealing quality can be achieved; the swelling behaviour therefore does not affect the armature length, but rather can be compensated for by the supporting spring.

In accordance with one conceivable refinement of the electromagnet, it can be provided that the penetration opening is arranged in the armature in a rectilinear manner in the longitudinal direction, preferably in a bore-like and/or stepped manner, preferably with a single step. This then results in the possibility that, if two closure elements are used, they are supported on one another via a common supporting spring. A floating and nevertheless supporting arrangement of the two closure elements in the armature can thus be realised in a simple way. In addition, the penetration opening can be configured in a simple way.

In accordance with one refinement of the electromagnet, the end winding/windings of the supporting springs which bears/bear against the sealing element/elements can be added and/or ground down. This results in a large contact area between the corresponding sealing element and a supporting spring, which large contact area makes satisfactory fixing and a homogeneous force flow possible. In addition, tilting or canting of the sealing element is reliably prevented, since no transverse forces are input into the corresponding sealing element. In addition, damage to the sealing element on account of pointed or sharp-edged spring-side run-out geometries is avoided. This embodiment also leads to no score marks or notches being configured in the sealing element at the spring-side end of the seal element over time as a result of the spring support, and a rotation of the sealing element relative to the supporting spring with regard to the longitudinal axis is possible in the long term. This movability also compensates for or avoids negative swelling-induced influences on the sealing quality. It is therefore conceivable that the at least one sealing element is arranged rotatably relative to the supporting spring with regard to the longitudinal axis. Here, the sealing element can be rotatable itself or separately from the guiding element, or can even be rotatable together with the respective guiding element.

In accordance with one refinement of the electromagnet, the guiding element can be configured from a thermoplastic material or as an MIM part, and/or the sealing element can be formed from a vulcanization-free material or from an elastic plastic, in particular elastomer, preferably an FKM material. The arrangement of the sealing element then makes the use of materials possible which have up to now not found or not been able to find any use or scarcely any use in this context. Previous materials for the guiding element and/or sealing element also always had to be capable of being adhesively bonded, vulcanized or welded.

The use of a thermoplastic for the guiding element makes complex geometries possible. In addition, thermoplastic material is comparatively light and therefore does not impede a rapid switching movement of the armature.

The configuration of the guiding element as an MIM part (metal injection moulding part) likewise makes complex geometries possible. A further advantage of the MIM production method is that the guide element can be produced with a complex geometry which can only be manufactured in multiple parts in conventional production processes, in a single piece with high geometric precision. Since the MIM injection moulding operation can be carried out in moulds with a plurality of cavities, the method is cost-effective for small, complex components in high numbers, as in the case of guiding elements.

In accordance with one conceivable refinement of the electromagnet, the at least one guiding element can be at least as long in the longitudinal direction as the sealing element. If two guiding elements are present, this can apply to both guiding elements. This makes reliable guiding possible and prevents an excessively short longitudinal extent which can lead to wobbling. If two guiding elements are present, it is conceivable that the longitudinal extent thereof is selected in such a way that they do not make contact in the case of a fully compressed supporting spring, that is to say a spacing is configured in between. This makes reliable spring and sealing function possible, and simple assembly.

The use of a material for the sealing element which does not have to be vulcanized on avoids all the disadvantages which are associated with vulcanizing-on. The sealing element can certainly itself be vulcanized from an elastomeric material, however. For example, PTFE (polytetrafluoroethylene) is conceivable as vulcanization-free material, since it is resistant to virtually all organic and inorganic chemicals, has a highly comprehensive area of use with regard to temperatures (approximately from −200° C. to +260° C.), has a very low coefficient of friction of approximately 0.03 and a pronounced anti-adhesive behaviour, and additionally has almost zero water absorption, which virtually rules out swelling. An ePTFE (expanded polytetrafluoroethylene) is also conceivable, for example, which, beyond the advantages of a PTFE material, additionally has highly satisfactory adaption capability to surfaces and therefore produces a perfect compensation for unevennesses of a sealing surface on the corresponding nozzle. Therefore, the nozzles no longer have to be manufactured with the perfection which has been required up to now, and greater tolerances can be permissible, which considerably decreases production costs. FEP (perfluoroethylene propylene copolymer), PFA (perfluoroalkoxy copolymer) and PVD (polyvinylidene fluoride) are also conceivable, for example, since they have properties which are comparable with PTFE.

Elastic plastics, for example elastomers, can also be used for the sealing element, however, in order to utilize the material-related advantages here. The sealing element does not have to be vulcanized-on or moulded-on as a separate component, for which reason it can also be made from an elastic plastic. Various FKM materials (fluororubber) are conceivable for the at least one sealing element, which materials, although they have satisfactory sealing properties, have poor bonding properties. The latter plays no role, since an FKM sealing element is not held in an integrally joined manner at all, and a bond of this type is therefore not present at all. The arrangement of the sealing element makes the use of materials possible, however, which up to now have not found or have not been able to find any or scarcely any use in this context.

In accordance with one refinement of the electromagnet, on the outer circumferential side, the sealing element can have a supporting step which can be supported against an inner circumferential-side supporting step of the guiding element. One or both supporting steps can be of annular configuration. Supporting steps of this type make exact positioning during assembly and during operation possible. The sealing element can be preloaded against the guiding element-side supporting step by the supporting spring.

In accordance with one refinement of the electromagnet, the supporting step of the sealing element can be arranged in the tenth to half of the longitudinal extent, facing the corresponding nozzle, of the sealing element. By virtue of the fact that a longitudinal spacing between the sealing surface of the sealing element and the supporting step of the sealing element is therefore much smaller than the longitudinal spacing between the supporting step of the sealing element and the supporting surface of the sealing element (surface, against which the supporting spring is supported), undesirable tilting or wobbling can be avoided or kept as low as possible during operation.

This refinement is also relevant with regard to the seal quality, however. The bearing of the two supporting steps against one another defines a longitudinal position of the sealing element in the guiding element, which longitudinal position is durable and still exists even after possible swelling. The abovementioned geometric configuration of the sealing element leads, however, to the longitudinal spacing between the sealing surface of the sealing element and the supporting step of the sealing element changing only slightly or in a scarcely noticeable manner as a result of swelling, while the longitudinal spacing between the supporting step of the sealing element and a supporting surface of the sealing element increases in a considerably more comprehensive manner. It is therefore conceivable that a ratio of a first longitudinal spacing between the sealing surface of the sealing element and the supporting step of the sealing element to a second longitudinal spacing between the supporting step of the sealing element and the supporting surface of the sealing element lies in the range from 1:1 to 1:10, preferably between 1:2 and 1:5, further preferably at 1:3. The swelling then namely does not change or scarcely changes a relative position of the sealing surface with respect to the armature, while the sealing element can nevertheless swell if this takes place at all, to be precise into the penetration opening or in the direction of the supporting spring which can compensate for this swelling-induced widening.

In accordance with one refinement of the electromagnet, the guiding element can have a hollow-cylindrical portion, in which the sealing element can be arranged. In addition, a second further hollow-cylindrical portion which adjoins the first hollow-cylindrical portion directly and has a different diameter is conceivable. The sealing element can also be arranged there. A supporting step can be configured between the two hollow-cylindrical portions. The at least one hollow-cylindrical portion can have, on the inner circumferential side in the region of the sealing element, a contact surface which can extend over a total angle of at least 180°, preferably 270°, further preferably 360°. The hollow-cylindrical portion can be configured so as to be closed on the circumferential side. This makes a sufficiently large contact and/or guiding surface for the sealing element possible. In addition or as an alternative, it is conceivable that the supporting spring engages into the hollow-cylindrical portion. On the inner circumferential side in the region of the supporting spring, the hollow-cylindrical portion preferably has a guiding surface, against which the supporting spring can bear. This guiding surface is preferably cylindrical, in order to hold and to mount the supporting spring therein in a reliably centred manner. Since the supporting spring also serves to reliably seal the nozzle by way of the sealing element, an embodiment of this type reliably achieves a situation where the supporting spring and the closure element can be assembled simply and can be used reliably. The hollow-cylindrical portion can configure an end region, facing a transverse centre plane of the armature, of the guiding element. As a result, undesirable turbulence when the medium flows around the guiding element can be avoided. The hollow-cylindrical portion can realise a homogeneous flow surface for the medium on the circumferential side. The contact surface and/or the guiding surface can be a cylindrical surface. This makes a rotation of the sealing element relative to the guiding element and/or of the supporting spring relative to the guiding element with regard to the longitudinal axis possible.

In accordance with one conceivable refinement of the electromagnet, the at least one supporting spring can have a supporting spring interior space which is delimited on the circumferential side by the windings of the supporting spring, and can have a spring clearance, through which flow can pass radially, the spring clearance being smaller than that circumferential area of the supporting spring interior space which is covered by the windings. The spring clearance can be configured between adjacent windings and can follow the windings. This relationship can be present in the state, in which the assembled spring is stretched to a maximum extent. As the supporting spring is compressed during operation, the spring clearance also logically decreases in size. It is conceivable that merely the region between two guiding elements is relevant for the covered circumferential area of the supporting spring interior space and the spring clearance. Therefore, that region of the spring which is flowed through radially, preferably by the medium, between its windings can be smaller than the thickness of the windings which prevent radial throughflow. As a result, an inflow of medium which is guided through the armature can advantageously be reduced and prevented. The medium can therefore flow on a direct path and without disadvantageous turbulence between the two end-side opening regions of the through-passage opening.

In accordance with one refinement of the electromagnet, the guiding element can be configured as a hollow sleeve and/or can have guiding ribs which run longitudinally on the circumferential side. It is therefore conceivable that the entire guiding element is a hollow sleeve, preferably a hollow sleeve with a single step. The hollow sleeve can comprise the hollow-cylindrical portion. Geometry of this type is low in complexity and makes a secure arrangement of the sealing element and the supporting spring possible.

In each case one flow region for the medium which flows into or out of the penetration opening can be provided between in each case two adjacent guiding ribs. The configuration can be selected here in such a way that the guiding ribs are arranged on the outer circumferential side on the hollow sleeve. The guiding ribs can bear against the penetration opening and can be guided by the latter. Here, the outer side of the guiding ribs assumes the guiding task or bearing task of the closure element in the penetration opening. The guiding ribs can extend over the entire length of the guiding element or over from 0.9 to 0.5 times the length of the guiding element, in order to make reliable guidance possible and to avoid tilting. The guiding element preferably has three or four equidistant guiding ribs.

The guiding ribs can in each case have an end-side bearing surface which can come into contact with the corresponding supporting flange. Here, the bearing surfaces of the guiding ribs can bear against the corresponding supporting flange in such a way that a throughflow of the medium through the flow region or the penetration opening is possible.

It is conceivable that the guiding ribs protrude in the longitudinal direction beyond an abrupt diameter change of the hollow-cylindrical portion or the hollow sleeve. The end-side bearing surfaces of the guiding ribs can be arranged radially adjacently with respect to the smaller external diameter of the hollow-cylindrical portion or the hollow sleeve. This configuration also makes it possible in an advantageous way that a throughflow of the medium through the flow region or the penetration opening is possible. At the same time, the guiding element can have a compact configuration.

In accordance with one refinement of the electromagnet, on the outer circumferential side, the guiding element can have at least one conical surface or curved surface. This conical surface or curved surface can extend in each case between two adjacent guiding ribs. The surfaces can optimize and/or follow an abrupt diameter change of the guiding element, for example on account of the supporting step, with regard to the flow of the medium, since a perpendicular surface would otherwise obstruct the medium.

In accordance with one refinement of the electromagnet, the guiding element can have a bounding collar which bears against the sealing element on the outer circumferential side. As a result, swelling-induced widening of the sealing element can be limited in the radial direction. In addition, in the case of contact with the corresponding nozzle, the sealing element cannot yield radially either, as a result of which a seal quality is ensured. It is conceivable that the sealing element bears completely against the guiding element on the outer circumferential side. Therefore, this effect can be realised over the entire length of the sealing element. It is conceivable that the sealing element does not project beyond the bounding collar in the longitudinal direction.

In accordance with one conceivable refinement of the electromagnet, the electromagnet can comprise a lid which is connected, preferably pressed, to the armature. The lid can serve to close the penetration opening after insertion of the components which are present there. In this way, elements which are otherwise customary such as a thread or a spring ring for closing the penetration opening can be dispensed with. Simple and rapid assembly is possible. The lid can have a reach-through, through which a closure element can reach. As a result, a seal function is also made possible on that side of the armature, on which the lid is arranged. The lid can configure an inner circumferential-side supporting flange, against which the closure element can bear or be preloaded. The lid can configure an outer circumferential-side supporting flange, against which a restoring spring can be supported. The lid can be configured or used as a tolerance compensation lid. A variable connecting length can be configured between the armature and the lid. As a result, the lid can be arranged on the armature with the required dimension, in order to adhere to a tolerance chain as a result. In addition, a tolerance chain can be shortened as a result. The connection between the lid and the armature can take place, for example, by pressing on, caulking, welding, lasering or adhesive bonding. As a result, the lid can be of particularly functionally integrated configuration, as a result of which separate components are avoided. In particular, the setting of the dimensional tolerance has a direct effect on the position of the supporting flange for the restoring spring via the lid. By means of a lid of this type, a spring force variance can be decreased considerably as a result. In addition, the armature itself can have a lower geometrical complexity on account of the lid and its various functions. This is certainly desirable, since armatures are usually formed from a metallic material and their production is therefore expensive as a consequence.

In accordance with one conceivable refinement of the electromagnet, the lid can be manufactured from stainless steel, a thermoplastic material or a non-ferrous metal. All of these materials/material groups are advantageously corrosion-resistant and/or magnetically non-conducting, and therefore do not have a negative influence on the magnetic flux and/or are sufficiently strong. Thermoplastic material is very particularly preferable, however, since the lid can be produced in a simple way as a result, for example by injection moulding, and a lid of this type can be pressed on in a simple way.

In accordance with one conceivable refinement of the electromagnet, the armature can have a recess in the region of the lid on the outer circumferential side, against which recess the lid does not bear, or over which recess the lid reaches with the configuration of an intermediate space. It is conceivable that the end side of the armature merges into the recess. The recess can also be an outer circumferential groove. This recess therefore does not take part in the connection to the lid. The armature and the lid can then be manufactured with an oversize fit in such a way that reliable pressing is possible and the lid can be pressed as far as possible onto the armature, preferably until the end surface of the armature bears against the lid.

In accordance with one conceivable refinement of the electromagnet, the armature can be of rotationally symmetrical configuration with regard to the longitudinal axis. A rotationally symmetrical construction of the armature results in a concentric arrangement of the penetration opening in relation to the longitudinal axis or movement direction of the armature.

In accordance with one conceivable refinement of the electromagnet, the sealing element can be of rotationally symmetrical configuration with regard to the longitudinal axis. The sealing element can comprise a first cylindrical portion and a second cylindrical portion with a smaller diameter in comparison with the first cylindrical portion, or can be formed therefrom. The cylindrical portions can adjoin one another directly in the longitudinal direction. The abrupt diameter change between the cylindrical portions can configure a supporting step. This supporting step can bear against a supporting step of the guiding element. A rotationally symmetrical construction of the sealing element results in a concentric arrangement of the sealing element in the guiding element in relation to the longitudinal axis or movement direction of the armature. In addition, an insertion direction for the sealing element does not have to be observed during assembly; it is therefore preferably not directional in the circumferential direction.

In accordance with one conceivable refinement of the electromagnet, the penetration opening can be realised as a bore. The armature itself can consist of solid material and/or can be cylindrical. It is also possible, however, that a tubular portion is used as armature and, as a result, the production of the armature becomes correspondingly simpler and less expensive, since machining is not necessary to make the often concentric, central penetration opening.

In accordance with one conceivable refinement of the electromagnet, the closure element can be configured in multiple pieces, preferably in two pieces. It is provided here in one preferred variant that the closure element is formed by a single-piece guiding element and a single-piece sealing element; it is of two-piece configuration. The single-piece guiding element can consist, for example, either in one piece from one material or else, although it is configured in one piece, from different materials which are, for example, co-extruded. Here, different functional regions can be configured with suitable materials.

In accordance with one conceivable refinement of the electromagnet, at least one supporting flange can be provided on or in the penetration opening. The corresponding closure element can be supported thereon. A supporting flange is preferably provided in the end region of the penetration opening and thus limits the adjusting travel of the corresponding closure element. The supporting flange nevertheless serves to avoid the closure element falling out of the penetration opening, in particular when the closure element is supported on the other side on a supporting spring. The supporting flange can be configured, for example, as a radially inwardly protruding (into the penetration opening in the end region) annular disc or annular disc portion of the armature or the lid, and otherwise leaves a passage for the throughflow of the medium free. The corresponding supporting flange can be configured in one piece with the armature or lid. Here, the penetration bore can be a stepped bore, preferably with a single step, it being possible for the step to configure a supporting flange. As a result, the penetration bore and the supporting flange there can be produced in a simple way. As a result, the separate fastening of the supporting flange to or in the penetration opening is dispensed with.

In accordance with one conceivable refinement of the electromagnet, the armature can be formed from a magnetizable material. The resulting material combination of the material of the guiding element, which slides on the inner circumferential surface of the armature in the penetration opening, and the armature results in a sufficiently smooth-running mounting of the at least one closure element.

In accordance with one conceivable refinement of the electromagnet, the working connector, the pressure connector and/or the venting connector can be connected to or into the armature space. A respective nozzle for the medium to be controlled can be situated in the orifice region of the respective connectors, which respective nozzle can be selectively closed or opened by way of the corresponding sealing element of the closure element.

In accordance with one conceivable refinement of the electromagnet, a first closed position can be achieved at a nozzle in the case of a deenergized coil. The restoring spring can preload the armature into this position. A second closed position at a nozzle can be achieved in the case of an energized coil and therefore an attracted armature.

In accordance with one conceivable refinement of the electromagnet, the supporting spring can be configured in such a way that contact of the armature with the magnetic core takes place or can take place in a closed position. As a result, the stop force is distributed between the armature and the sealing element, but the closure element then dips further into the penetration bore counter to the spring force of the supporting spring. This embodiment protects the sealing element, but surface damage and, as a consequence, bursting of one or the two elements can occur on account of the contact between the armature and the magnetic core. In order to release any possible magnetic clinging between the armature and the core after the coil winding has been deenergized, the supporting spring can be of corresponding configuration and/or can assist the restoring spring.

In accordance with one conceivable refinement of the electromagnet, the supporting spring can be configured as an alternative in such a way that contact of the armature with the magnetic core does not take place or cannot take place in a closed position. As a result, a remaining air gap or a residual gap remains between the armature and the magnetic core in this closed position. As a result, although the entire stop force is introduced into the sealing element, which can lead to surface damage in the case of a long service life, the respective surfaces of the armature and the magnetic core are treated more gently.

In accordance with one conceivable refinement of the electromagnet, the coil body and/or pole tube can surround and/or circumferentially delimit the armature space at least partially, and/or a gas or a liquid can be provided as medium.

In accordance with one conceivable refinement of the electromagnet, a working connector, a pressure connector and/or a venting connector can be connected to the armature space, preferably directly.

In accordance with one conceivable refinement of the electromagnet, a nozzle which can be closed and opened by way of the respective closure element can be arranged at the armature space-side end of the venting connector and/or pressure connector, and/or the nozzle can be formed from an elastomer material.

In accordance with one conceivable refinement of the electromagnet, the electromagnet can be configured as a solenoid valve. The advantages particularly come into effect precisely in this technical context.

The refinements described for a closure element, guiding element and/or sealing element can as it were also apply to a second closure element, guiding element and/or sealing element which can likewise be arranged in the penetration opening.

Production is to be understood to mean a process, by way of which a component is manufactured. Assembly is to be understood to mean a process, by way of which the produced component is fixed at or in its intended operational location. The produced components are assembled to form the electromagnet by way of the assembly.

### BRIEF DESCRIPTION OF THE DRAWINGS

Further features, details and advantages of the invention result from the wording of the claims and the following description of exemplary embodiments on the basis of the drawings, in which:

FIG. 1 shows a longitudinal sectional view of an electromagnet.

FIG. 2 shows a side view of a closure element from FIG. 1.

FIG. 3 shows a plan view of the closure element from FIG. 1.

FIG. 4 shows a perspective view of the closure element from FIG. 1.

FIG. 5 shows a longitudinal sectional view of an armature from FIG. 1.

### DETAILED DESCRIPTION

In the figures, elements which are identical or correspond to one another are denoted in each case by the same reference signs and are therefore not described again, unless expedient. Features which have already been described are not described again in order to avoid repetitions, and can be applied to all elements with reference signs which are identical or correspond to one another, unless explicitly ruled out. The disclosures contained in the entire description can be transferred mutatis mutandis to identical parts with identical reference signs or identical component designations. The positional specifications selected in the description such as, for example, top, bottom, side, etc. also relate to the figure which is directly described and shown, and can be transferred mutatis mutandis to the new position in the case of a positional change. Furthermore, individual features or combinations of features from the different exemplary embodiments which are shown and described can also represent solutions which are independent per se, inventive, or in accordance with the invention.

A radial direction R extends starting from a longitudinal axis A or central longitudinal axis. A circumferential direction U extends around the central longitudinal axis A, and a transverse centre plane Q is arranged in such a way that its normal vector lies on the central longitudinal axis A. In addition, a longitudinal direction L extends along the longitudinal axis A.

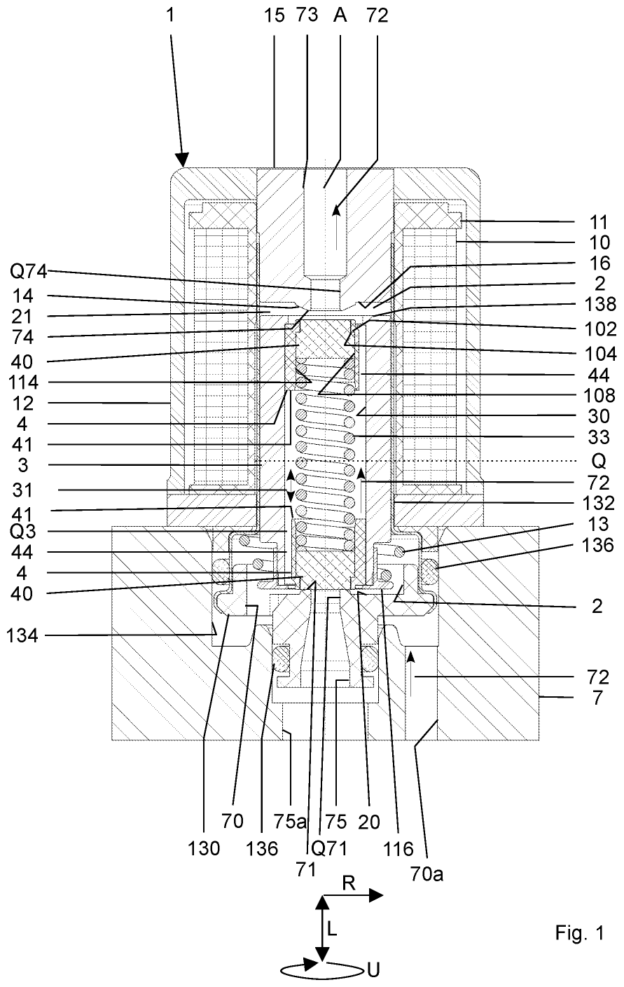

FIG. 1 shows a longitudinal sectional view of the electromagnet 1. The electromagnet 1 which is shown here can also be called a solenoid valve, and is penetrated by the longitudinal axis A. The electromagnet 1 comprises a magnet housing 12 in a known way, which magnet housing 12 accommodates a coil body 11 which supports a coil winding 10. In addition, the electromagnet 1 comprises a magnetic core 15 which is supported by the magnet housing 12. The electromagnet 1 has a connector part 130 at the end which lies opposite the magnetic core 15. Merely for reasons of illustration, the electromagnet 1 is inserted via the connector part 130 into a connector housing 7 or cartridge which does not have to be a constituent part of the electromagnet 1. Customers typically already have connector housings 7 of this type, which have merely corresponding receiving geometries for the electromagnet 1 such as, for example, an insert recess 134 for inserting the electromagnet 1. In addition, the electromagnet 1 comprises a pole tube 132 which is held at one end and a gap between the coil body 11 and the magnetic core 15, and at the other end supports the connector part 130 in a positively locking and/or non-positive manner. The electromagnet 1 is sealed with respect to the connector housing 7 via two sealing rings 136.

An armature space 2 of the electromagnet 1 is delimited on the circumferential side by the pole tube 132 and axially at one end by the magnetic core 15 and axially at the other end by the connector part 130. The connector part 130 configures an armature space bottom 20. An armature 3 is arranged longitudinally movably in the armature space 2. The armature 3 is preloaded into the shown position by a restoring spring 13 into a first closed position; the coil winding 10 is deenergized. In the energized state of the coil winding 10, the armature 3 is adjusted in a known way within the armature space 2, with the result that it is pulled upwards in the plane of the drawing in the direction of the magnetic core 15, this taking place counter to the spring force of the restoring spring 13. As a result, an air gap 21 is decreased or is closed. This position can be a second closed position. After deenergization of the coil winding 10, the armature 3 is reset into the shown position by way of the restoring spring 13 and/or a supporting spring 33.

The armature 3 is of rotationally symmetrical configuration with regard to the longitudinal axis A, is an armature, through which flow passes in the interior, and avoids being flowed around by virtue of the fact that its armature shell surface is a closed armature shell surface, for example a cylindrical armature shell surface. The armature 3 has a continuous penetration opening 30 which runs in the longitudinal direction L and is configured with a single step. The single step results from the fact that the penetration opening 30 has only a first portion with a greater diameter and a second portion 34 with a smaller diameter. The penetration opening 30 has end-side opening regions at both ends.

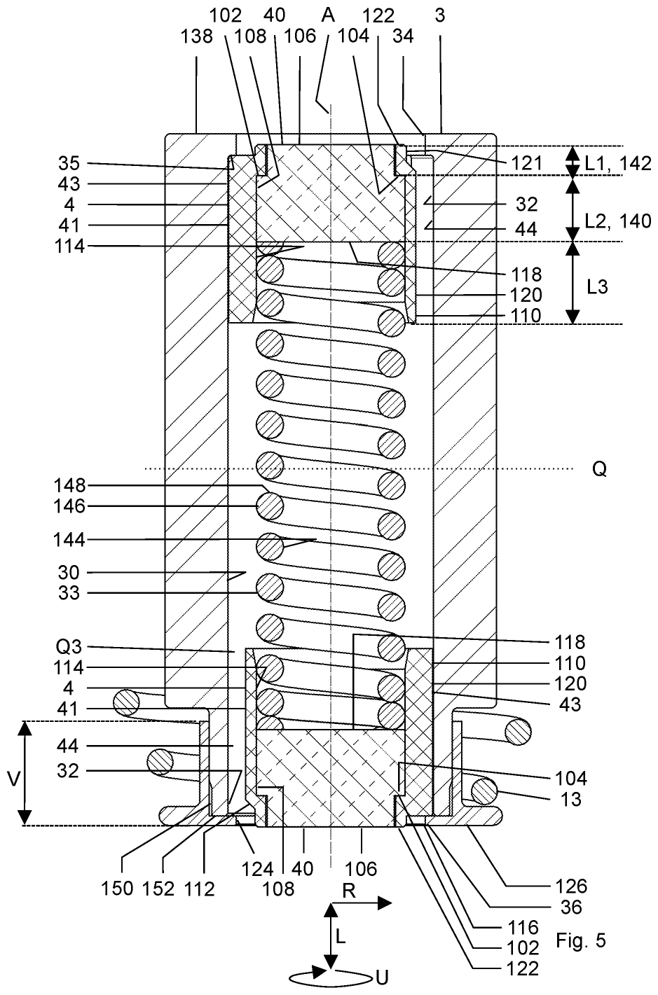

A closure element 4 is arranged in each case in the two axial end regions 32 of the penetration opening 30. The two closure elements 4 are mounted in a floating manner in the penetration opening 30. In addition, the supporting spring 33, against which the two closure elements 4 are supported, is received in the penetration opening 30. At one end, the armature 3 comprises a lid 116 which is pressed onto the armature 3. In the connected state (here, in the pressed state), the lid 116 engages over an outer circumferential-side recess 150 or an outer circumferential groove of the armature 3 with configuration of an intermediate space. The lid does not bear against the recess 150. That end surface 152 of the armature which bears against the lid 116 merges directly into the recess 150. The lid 116 closes the penetration opening 30 and has a reach-through 124, as shown in FIG. 5, in particular. The lid 116 configures an inner circumferential-side supporting flange 36, against which the closure element 4 is preloaded by supporting spring 33. For the other closure element 4, the armature 3 configures an inner circumferential-side supporting flange 35, against which the closure element 4 is preloaded by supporting spring 33. The supporting flange 35 of the armature 3 is formed by way of the single step.

The connector part 130 has a working connector 70 and a pressure connector 75, and the magnetic core 15 has a venting connector 73. All of these connectors 73 and 75 adjoin the armature space 2, in each case one nozzle 71, 74 being arranged on the armature space side at the orifice region on the venting connector 73 and on the pressure connector 75. The nozzles 71, 74 configure the orifice region of the respective connector line 73, 75 and in each case one sealing seat. Each nozzle 71, 74 is assigned a closure element 4 which opens or closes the respective nozzle 71, 74 in a manner which is dependent on the armature position. The connector housing 7 has a feed line for the working connector 70 and a feed line 75a for the pressure connector. It can be seen in combination with FIG. 3 that a cross-sectional area Q3, through which flow can pass, of the armature 3 is greater than a cross-sectional area Q71, Q74, through which flow can pass, of the nozzles 71, 74. The cross-sectional areas Q71, Q74, through which flow can pass, are configured in each case in the flow region 44.

The nozzle 74 is formed by a projecting nozzle ring 14, which results in a circumferential shoulder 16 on the end side of the magnetic core 15. This shoulder 16 interacts with an annular portion 138 in the opposite region of the armature 3, as a result of which the magnetic properties (force-current characteristic curves, etc.) of the electro-magnet 1 can be set in a known way. The annular portion 138 configures the portion 34 with a smaller diameter of the penetration opening 30, but does not have to do so. The nozzle 74 can dip into this portion 34.

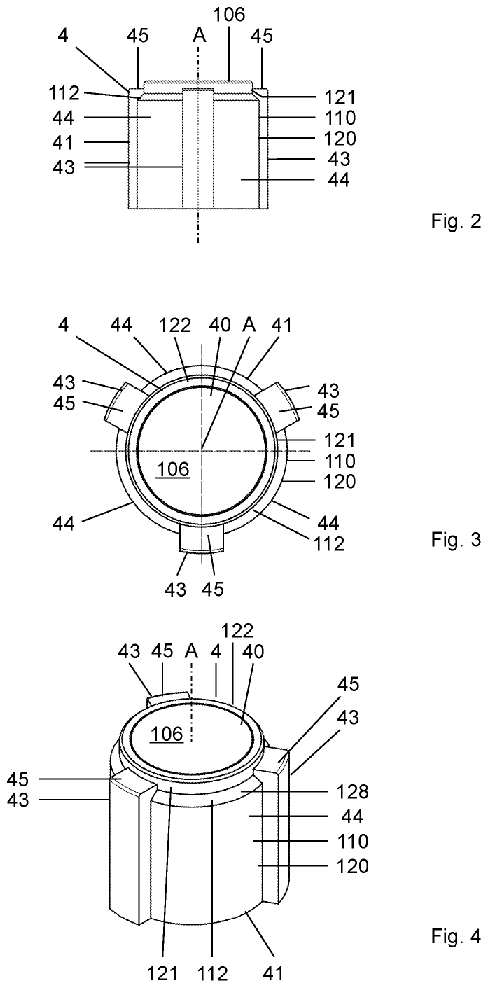

The armature 3 and one of the two closure elements 4 (representing the two closure elements 4) are now to be described in detail with regard to FIGS. 2 to 5. The closure elements 4 are of identical configuration, but do not have to be.

The closure element 4 comprises or is formed from two parts, namely a sealing element 40 and a guiding element 41. The sealing element 40 is a separate component from the guiding element 41 and is produced separately from the latter. The sealing element 40 is pressed into the guiding element and is held there, although other possibilities are also conceivable within the context of non-positive and/or positively locking or floating holding. The sealing element 40 is of rotationally symmetrical configuration with regard to the longitudinal axis A, and at one end comprises a sealing surface 106 which serves for contact with the respective nozzle 71, 74, and at the other end comprises a supporting surface 118 which serves for support against the supporting spring 33. The sealing element 40 comprises a first cylindrical portion 140 and a second cylindrical portion 142 with a smaller diameter in comparison with the former. The cylindrical portions 140, 142 adjoin one another directly. The abrupt diameter change between the cylindrical portions 140, 142 configures a supporting step 102.

The guiding element 41 is configured as a hollow sleeve 110 which has a first hollow-cylindrical portion 120 and a second hollow-cylindrical portion 121 with a smaller diameter in comparison with the former. The abrupt diameter change 128 between the hollow-cylindrical portions 120, 121 configures a supporting step 104. The first hollow-cylindrical portion 120 configures an end region, facing the transverse centre plane Q of the armature 3, of the guiding element 41. The second hollow-cylindrical portion 121 defines an annular bounding collar 122, coaxially with respect to the longitudinal axis A. The two hollow-cylindrical portions 120, 121 each have a cylindrical surface on the inner circumferential side. The sealing element 40 is held via one or both of these cylindrical surfaces, for which reason the one or two contact surfaces 108 are correspondingly configured. The supporting spring 33 engages into the hollow-cylindrical portion 120. The engagement lengths can be denoted by a longitudinal spacing L3. L3 can correspond to half the entire longitudinal extent of the guiding element 41. In the region of the supporting spring 33, on the inner circumferential side, the hollow-cylindrical portion 120 has a guiding surface 114, against which the supporting spring 33 can bear. The corresponding cylindrical surface can configure the guiding surface 114.

In the case of the sealing element 40, a first longitudinal spacing L1 can be plotted between the sealing surface 106 and the supporting step 102 of the sealing element 40. In the case of the sealing element 40, a second longitudinal spacing L2 can be plotted between the supporting step 102 of the sealing element 40 and the supporting surface 118. The first longitudinal spacing L1 is preferably less than or considerably less than the second longitudinal spacing L2. The following can apply: L1+L2=L3. This can serve for reliable guidance of the spring 33 and the sealing element 40. It can additionally be seen that the supporting step 102 of the sealing element 40 is arranged in that third of the longitudinal extent of the sealing element 40 which faces the corresponding nozzle 71, 74. The supporting steps 102 and 104 bear against one another.

On the outer circumferential side, the guiding element 41 has a plurality of equidistant and longitudinally running guiding ribs 43. A flow region 44 for the medium which flows into or out of the penetration opening 30 is provided in each case between two adjacent guiding ribs 43. The guiding ribs 43 bear in the penetration opening 30 against the armature 3, and guide the closure element 4 therein. The guiding ribs 43 do not extend over the entire length of the guiding element 41, but merely over the entire length of the hollow-cylindrical portion 120 and over half the length of the hollow-cylindrical portion 121. The guiding ribs 43 protrude beyond the abrupt diameter change 128 of the hollow sleeve 110 in the longitudinal direction L. The guiding ribs 43 each have an end-side bearing surface 45 which can come into contact with the corresponding supporting flange 36, 36. The end-side bearing surfaces 45 are arranged radially adjacently with respect to the hollow-cylindrical portion 121. On the outer circumferential side, the guiding element 41 has a plurality of conical surfaces 112 which each extend between two adjacent guiding ribs 43. These conical surfaces 112 optimize and follow the abrupt diameter change 128 of the guiding element 41.

The two-sided end windings of the supporting spring 33 are added and ground down. The sealing elements 40 are supported via their supporting surface 118 directly on the supporting spring 33.

The lid 116 configures an outer circumferential-side annular supporting flange 126, against which the restoring spring 13 can be supported. At the other end, the restoring spring 13 is supported against the poll tube 132. For the tolerance compensation function during assembly, a variable connecting length V is configured between the armature 3 and the lid 116.

In the illustrated position of the armature 3, the lower (in the plane of the drawing) closure element 4 presses with its sealing element 40 onto the edge of the nozzle 71 at the pressure connector 75. Here, the nozzle 71 of the pressure connector 75 is provided in the armature space bottom 20, the armature space bottom 20 being part of the connector part 130 here.

In the position shown here of the electromagnet 1 (typically, a 3/2-way valve), a media flow direction 72 is realised in such a way that the venting connector 73 is open and there is thus a connection between the working connector 70 and the venting connector 73. It is possible as a result that the working connector 70 is vented via the venting connector 73. This position can be a first closed position; the pressure connector is closed. If the coil winding 10 is energized, the armature 3 moves and a second closed position can be reached. In this position, the venting connector 73 is closed via the corresponding closure element 4, and a connection between the working connector and the pressure connector 75 is established.

The armature 3 is mounted longitudinally movably (along the double arrow 31) in the armature space 2. The lower end of the penetration opening 30 is oriented in the direction of the (lower) nozzle 71 of the pressure connector 75, whereas the upper end of the penetration opening 30 is arranged in the region of the (upper) nozzle 74 of the venting connector 73. As a result of the penetration opening 30, the armature 3 counteracts the medium situated in the armature space 2 with a low resistance on account of its increasing (energized) or decreasing (deenergized) movement (double arrow 31), since the medium in the interior of the armature 3 can flow into and out of the penetration opening 30. Although this flow movement is impaired slightly by way of the closure elements 4 which are arranged in the penetration opening 30, it is not prevented. There is a communicating connection between the remaining armature space 2 and the interior of the armature 3, in the penetration opening 30, even in the case of closure elements 4 being inserted. This possibility results from the specific configuration of the closure element 4 which becomes clear in FIGS. 2 to 5, in particular. The closure element 4 has at least two different functions or else two different part regions. The guiding element 41 serves to guide and to allow medium through, whereas the sealing element 40 serves for the sealing function in the case of the closed position of the armature 3 with regard to the respective nozzle 71, 74.

In particular, FIG. 5 shows a supporting spring interior space 144 of the supporting spring 33. It is delimited on the end side by the respective supporting surfaces 118 and on the outer circumferential side by the windings 146 of the supporting spring 33. The supporting spring interior space 144 can be connected fluidically to a surrounding area of the supporting spring 33, namely via the winding intermediate space or the spring clearance 148. The spring clearance 148 is smaller than that circumferential area of the supporting spring interior space 144 which is covered by the windings 146.

The invention is not restricted to one of the above-described embodiments, but rather can be modified in a wide variety of ways. All of the features and advantages which are apparent from the claims, the description and the drawing, including structural details, spatial arrangements and method steps, can be essential to the invention both per se and in a very wide variety of combinations.

All combinations of at least two of the features disclosed in the description, the claims and/or the figures fall within the scope of the invention.

In order to avoid repetitions, features which are disclosed in accordance with the apparatus are also considered to be disclosed and capable of being claimed in accordance with the method. Features which are disclosed in accordance with the method are likewise to be considered to be disclosed and capable of being claimed in accordance with the apparatus.

### LIST OF REFERENCE SIGNS

| | |
|---|---|
| 1 | Electromagnet |
| 2 | Armature space |
| 3 | Armature |
| 4 | Closure element |
| 7 | Connector housing |
| 10 | Coil winding |
| 11 | Coil body |
| 12 | Magnet housing |
| 13 | Restoring spring |
| 14 | Nozzle ring |
| 15 | Magnetic core |
| 16 | Shoulder |
| 20 | Armature space bottom |
| 21 | Air gap |
| 30 | Penetration opening |
| 31 | Double arrow |
| 32 | End region |
| 33 | Supporting spring |
| 34 | Portion |
| 35 | Supporting flange |
| 36 | Supporting flange |
| 40 | Sealing element |
| 41 | Guiding element |
| 43 | Guiding rib |
| 44 | Flow region |
| 45 | Contact surface |
| 70 | Working connector |
| 70a | Feed line |
| 71 | Nozzle |
| 72 | Media flow direction |
| 73 | Venting connector |
| 74 | Nozzle |
| 75 | Pressure connector |
| 75a | Feed line |
| 102 | Supporting step |
| 104 | Supporting step |
| 106 | Sealing surface |
| 108 | Contact surface |
| 110 | Hollow sleeve |
| 112 | Conical surface |
| 114 | Guiding surface |
| 116 | Lid |
| 118 | Supporting surface |
| 120 | Hollow-cylindrical portion |
| 121 | Hollow-cylindrical portion |
| 122 | Bounding collar |
| 124 | Reach-through |
| 126 | Supporting flange |
| 128 | Abrupt diameter change |
| 130 | Connector part |
| 132 | Pole tube |
| 134 | Insert recess |
| 136 | Sealing ring |
| 138 | Annular portion |
| 140 | First cylindrical portion |
| 142 | Second cylindrical portion |
| 144 | Supporting spring interior space |
| 146 | Winding |
| 148 | Spring clearance |
| 150 | Recess |
| 152 | End surface |
| A | Longitudinal axis |
| L | Longitudinal direction |
| L1 | First longitudinal spacing |
| L2 | Second longitudinal spacing |
| L3 | Third longitudinal spacing |
| R | Radial direction |
| Q | Transverse centre plane |
| Q3, Q71, Q74 | Cross-sectional area |
| U | Circumferential direction |
| V | Connecting length |

1. An electromagnet which is penetrated by a longitudinal axis (A), comprising:
an armature space;
an armature which is arranged longitudinally movably in the armature space, the armature having a penetration opening,
at least one closure element, and
at least one nozzle,
wherein the armature supports the at least one closure element which is mounted movably in the penetration opening,
wherein the at least one closure element is configured to open or to close the at least one nozzle,
wherein the at least one closure element comprises:
a guiding element configured to guide the at least one closure element in the penetration opening, and
a sealing element which is supported by the guiding element, and is held in a non-positive and/or positively locking or floating manner on the guiding element.

2. The electromagnet according to claim 1, wherein the at least one closure element further comprises a supporting spring, wherein the supporting spring is provided in the penetration opening, the sealing element being supported by the supporting spring.

3. The electromagnet according to claim 2, wherein an end winding of the supporting spring which bears against the sealing element is added and/or ground down.

4. The electromagnet according to claim 1, wherein the guiding element is configured from a thermoplastic material or as a metal injection moulding (MIM) part.

5. The electromagnet according to claim 1, wherein on an outer circumferential side of the sealing element, the sealing element has a supporting step which is supported against an inner circumferential-side supporting step of the guiding element.

6. The electromagnet according to claim 5, wherein the supporting step of the sealing element is arranged in a tenth or half, facing the at least one nozzle, of a longitudinal extent of the sealing element.

7. The electromagnet according to claim 1, wherein the guiding element has a hollow cylindrical portion in which the sealing element is arranged.

8. The electromagnet according to claim 1, wherein the guiding element is configured as a hollow sleeve and/or has guiding ribs which run longitudinally on an outer circumferential side of the guiding element.

9. The electromagnet according to claim 8, wherein on the outer circumferential side, the guiding element has at least one conical surface or curved surface.

10. The electromagnet according to claim 1, wherein the guiding element has a bounding collar which bears against the sealing element on an outer circumferential side of the guiding element.

11. The electromagnet according to claim 1, wherein the sealing element is formed from a vulcanization-free material or from an elastic plastic.

12. The electromagnet according to claim 1, wherein the sealing element is formed from an elastomer.

13. The electromagnet according to claim 12, wherein the sealing element is formed from a fluoro-rubber (FKM) material.
